(19) United States
(12) Patent Application Publication
(10) Pub. No.: US 2009/0222276 A1
(43) Pub. Date: Sep. 3, 2009

(54) Apparatus, System, and Method for Cloning Web Page Designs or Avatar Designs

(76) Inventors: Todd Harold Romney, Midvale, UT (US); Miles David Romney, Midway, UT (US)

Correspondence Address: Todd Romney, 6905 S. 1300 E. #466, Midvale, UT, 84047, US

(21) Appl. No.: 12/040,916

(22) Filed: Mar. 2, 2008

(51) Int. Cl. G06Q 30/00; G06F 7/00; G06Q 20/00; G06F 17/30

(52) U.S. Cl. 705/1; 707/104.1; 705/35; 707/E17.116

(57) ABSTRACT

An apparatus, system, and method are disclosed for facilitating the copying or cloning of web page and avatar designs.

### RELATED APPLICATIONS

This application claims priority to the provisional application for the APPARATUS, SYSTEM, AND METHOD FOR CLONING WEB PAGE AND AVATAR DESIGNS filed on Mar. 2, 2007.

### BACKGROUND OF THE INVENTION

1. Field of the Invention

This invention relates to the copying of web page or avatar design elements, and the automated replacement of the original information elements within the web page or avatar with a new set of information elements.

2. Description of the Related Art

The Internet age has created a new form of communication. Through the use of the Internet multi-media platform, individuals are able to create personal web pages that provide a detailed description of the individual, and their life. Personal attributes, such as blogs, pictures, audio clips, videos, and text descriptions of the individual's physical attributes, likes and dislikes, hobbies, and a wide range of other attributes and information elements can be easily shared with friends, families, and the general population. These pages are commonly referred to as “profiles” and are often aggregated on a web site that enables easy interaction between the individuals through their respective profile pages.

The design of the page, referring to the web page layout and graphical elements, has become an important means of self-expression, and also a means of making an individual's profile page stand out. An entire industry has built-up around the custom design of profile pages for major aggregation sites. By and large this has been due to the fact that, until recently, web page design required extensive knowledge of HyperText Markup Language (HTML), and other related web application languages. Recent advances in web application graphical user interfaces (GUIs) have made it possible for people with minimal knowledge of HTML to create their own web page designs. This has created the possibility of a dramatic increase in the number of people capable of creating unique web page designs.

Just like people enjoy sharing their favorite recipe with their friends, people may enjoy sharing their favorite profile design with others. They may choose to make the profile web page design they created available for free, or they may want to charge a fee for the profile web design.

Likewise, user two may view user one's profile web page and desire to use the same, or a very similar, web page design for user two's profile web page. Currently, that would require user two to manually create a new web page design based on the design user one created. There currently is no system that easily allows user two to copy the web page design of another user that chooses to make the web page design available for others to copy.

As technology moves forward, there is a natural migration from two-dimensional profile descriptions to three-dimensional representations of the individual described in the profile. These three-dimensional representations are typically computer generated animation characters referred to avatars. The avatar still has design parameters—such as appearance, clothing, etc.—associated with it, and will also have the personal attribute elements and information elements—such as age, interests, blogs, pictures, etc.—it is intended to share and communicate to others. Custom avatar designs will likely be just as important as custom profile web page designs as a means of self-expression and differentiation. Again, individual users may want the means to easily and rapidly share a particular design with others, and there is currently no system available that enables individual users to easily accomplish this.

From the foregoing discussion, it should be apparent that a need exists for an apparatus, system, and method for facilitating the cloning of web page and avatar designs. The apparatus, system, and method should ensure that the creator of the design is able to choose whether or not the creator wants the design to be available for copying by others, whether the creator wants to make the design available to be copied for free or for a fee, give the creator credit for the design, and automatically replace the creator's personal attribute elements with the copier's personal attribute elements.

The present invention has been developed in response to the present state of the art, and in particular, in response to the problems and needs in the art that have not yet been fully solved by currently available methods of facilitating the sharing of web page and avatar designs. Accordingly, the present invention has been developed to provide an apparatus, system, and method for cloning web page and avatar designs that overcome many or all of the above-discussed shortcomings in the art.

### SUMMARY OF THE INVENTION

The apparatus for facilitating the cloning of web page and avatar designs is provided with a logic unit containing a plurality of modules configured to functionally execute the steps of facilitating web page and avatar design cloning. These modules in the described embodiments include a receiver module, a channel module, a transfer module, a communications module, a communications encryption module, a data encryption module, and an online purchase module. Preferably, the apparatus includes a handler module, a user account module, a user account database, a graphical user interface (GUI) construct module, a web page or avatar design database, and a web page or avatar personal attributes and information elements database.

The apparatus allows the creator of the web page or avatar design to choose to make the design available for other users of the system, either free of charge, or for a fee. The channel module establishes an electronic communication channel between the apparatus and other users. The receiver and transfer modules enable other users to view the web page or avatar. The handler module brokers electronic content transfer between the user account module, design database module, and the personal attribute database model, enabling other users viewing the web page or avatar to use the design for their own purposes. In one embodiment, the handler module replaces the creator's personal attribute elements and information elements displayed as a part of the web page or avatar, with the corresponding personal attribute elements and information elements of the new user of the web page or avatar design.

The creator begins by signing on to the system by providing required access elements to the receiver module. Once the receiver module has received the required access elements, the channel module establishes an electronic communication channel between the GUI construct module and the creator. In one embodiment, the electronic communication channel may be either an asynchronous communication channel or a synchronous communication channel.

The creator uses the GUI construct module to create the web page or avatar design. The creator selects to allow the design to be created, and the fee (if any) to be charged for copying the design. In one embodiment, the design elements are stored in the web page and avatar design database module, and the personal attribute elements associated with the creator are stored in the user web page and avatar personal attributes database.

The copier establishes communication with the system in the same fashion as the creator. The copier's name is added to the web page or avatar design's modification tracking list. To display the creator's profile web page, in one embodiment, the GUI construct module receives and combines the creator's personal attribute elements and the design elements from the user web page personal attributes database and the web page design database. The copier views the profile web page or avatar created by the creator, and desires to use the design for his own purposes. The copier selects to clone or copy selected elements or the entire the design.

If a fee is required to copy the design, communication is established with the online purchase module and the copier. The copier provides the necessary purchase data to the online purchase module, and the purchase is executed.

Once the purchase requirements have been fulfilled, in one embodiment, the handler module gives the copier's account access to the copied design. In another embodiment, the handler module copies the design elements to the copier's account in the web page and avatar design database.

Electronic notification of the transaction is sent by the communication module to the creator and copier.

In one embodiment, if the copier makes changes to the design, the copier's name is added to the design's modification tracking list. The copier chooses to use the design for a web page or avatar. When the web page or avatar is used, in one embodiment, the GUI construct module combines the design elements from the web page and avatar design database with the copier's personal attribute elements from the user web page or avatar personal attribute database.

A third party sees the web page or avatar, and desires to use the design as well. The process is repeated, with each successive copier having access to designated elements of both the original creator's design and the design modifications made by previous copiers.

A system of the present invention is also presented for facilitating web page and avatar design cloning. The system, in one embodiment, includes a web page or avatar design cloning interface application, an electronic communication utility, a network server, a repository, and a communication network.

A method for facilitating web page and avatar design cloning. The method in the disclosed embodiments substantially includes the steps necessary to carry out the functions presented above with respect to the operation of the described apparatus and system.

### BRIEF DESCRIPTION OF THE DRAWINGS

In order that the advantages of the invention will be readily understood, a particular description of the invention will be rendered by reference to specific embodiments that are illustrated in the appended drawings. Understanding that these drawings depict only typical embodiments of the invention and are not, therefore, to be considered to be limiting of its scope, the invention will be described and explained with additional specificity and detail through the use of the accompanying drawings, in which:

FIG. 1 is a schematic diagram illustrating one embodiment of a system for cloning web page designs or avatar designs with the present invention;

FIG. 2 is a schematic block diagram illustrating one embodiment of user-side apparatus for cloning web page designs or avatar designs;

FIG. 3 is a schematic block diagram illustrating one embodiment of a server-side apparatus for cloning web page designs or avatar designs;

FIG. 4 is a schematic flow chart diagram illustrating one embodiment of a method of cloning web page designs or avatar designs;

### DETAILED DESCRIPTION OF THE INVENTION

The invention comprises a system, method and apparatus for copying a web page design or avatar design and enabling that design to be rapidly configured for the use of another person. Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

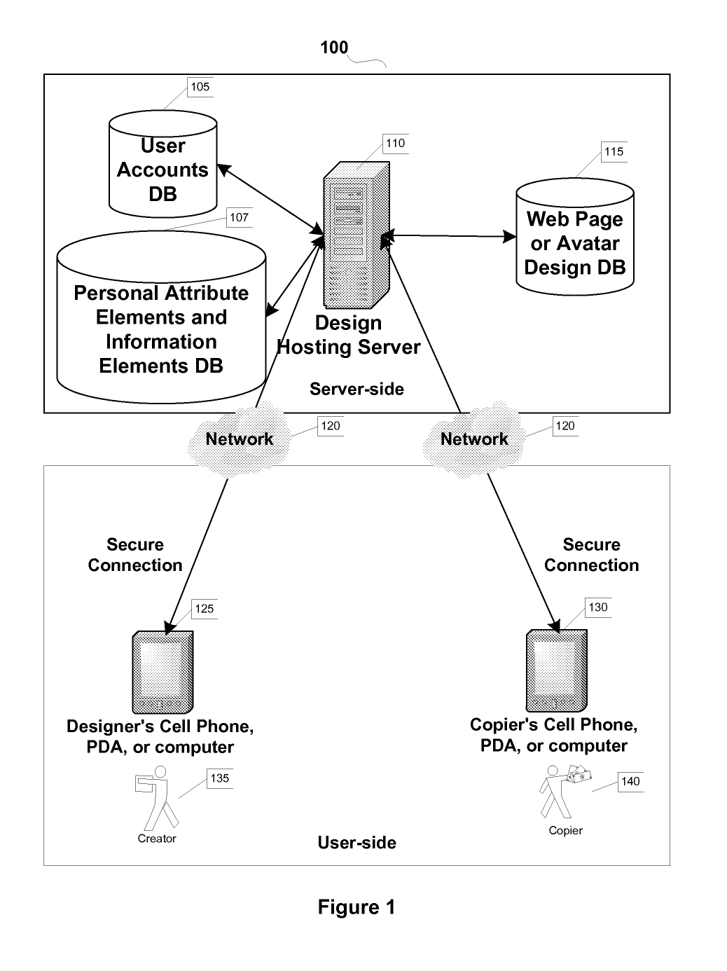

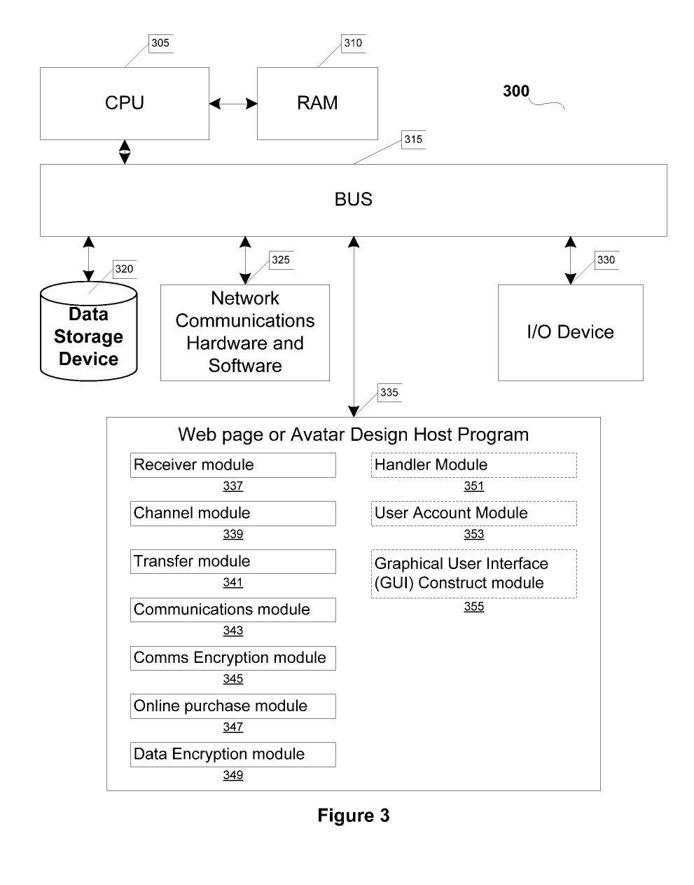

FIG. 1 is a schematic diagram illustrating one embodiment of a system for cloning web page designs or avatar designs 100 in accordance with the present invention. As depicted, a Design Hosting Server 110 communicates with a User Accounts Database 105, a personal attribute elements and information elements database 107, and with a Web Page or Avatar Design Database 115. The Creator 135 uses a remote communication device 125 to communicate with the Design Hosting Server 110 through a Remote Contact Network 120. The Copier 140 also uses a Remote Communication Device 130 to communicate with the Design Hosting Server 110 via the Remote Contact Network 120. In the depicted embodiment, the Design Hosting Server 110 contains the apparatus depicted in FIG. 3, and runs the Web Page or Avatar Design Host Program 335.

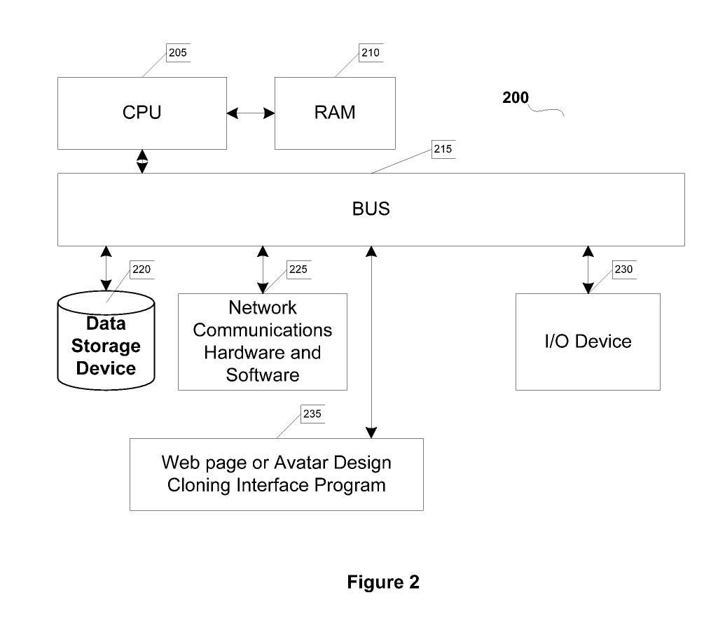

FIG. 2 is a schematic block diagram illustrating one embodiment of user-side apparatus 200 for cloning web page designs or avatar designs. As depicted, the apparatus users (Creator 135 and Copier 140) employ a computer-like device typically using a Central Processing Unit 205, Random Access Memory 210, an Interface Bus 215, a Data Storage Device 220, and Input/Output Device 230, and Network Communications Hardware and/or Software 225. The computer device runs a program of instructions, the Web Page or Avatar Design Cloning Interface Program 235, which enables the users to interface with the Design Hosting Server 110.

FIG. 3 is a schematic block diagram illustrating one embodiment of a server-side apparatus 300 for cloning web page designs or avatar designs. As depicted, the server side apparatus 300 includes a computer like device typically using a Central Processing Unit 305, Random Access Memory 310, an Interface Bus 315, a Data Storage Device 320, and Input/Output Device 330, and Network communications hardware and/or software 325. The computer device runs a program of instructions, the Web Page or Avatar Design Host Program 335, which carry out the functions of the web page or avatar design cloning system.

In the depicted embodiment, the Web Page or Avatar Design Host Program 335 contains a Receiver module 337, a Channel module 339, a Transfer module 341, a Communications module 343, a Comms Encryption module 345, an Online Purchase module 347, a Data Encryption module 349, a Handler module 351, a User Account module 353, and a Graphical User Interface (GUI) Construct module 355. The Receiver module 337 receives inputs and instructions from outside the program. The Channel module 339 establishes a communications channel with other parts of the apparatus 300. The Transfer module 341 controls the transfer of data from one part of the apparatus 300 to another part of the apparatus 300, as well as from one part of the system 100 to another part of the system 100. The Communications module 343 controls communications to and from the Creator 135 and the Copier 140. The Comms Encryption module 345 facilitates the secure transmission of data to and from the Creator 135 and the Copier 140. The Online Purchase module 347 contains the set of instructions necessary for carrying out the online purchase by the Copier 140 for the cloning fee (if applicable) prescribed by the Creator 135. The Data Encryption module 349 contains the set of instructions needed for encrypting personal attribute elements or information elements on the Personal Attribute Elements and Information Elements Database 107. The Handler module 351 contains the set of instructions for copying a web page or avatar design from the Creator to the Copier while ensuring that none of the Creator's personal attribute elements and information elements are copied, and also updating the web page or avatar design's modification tracking list. The User Account module 353 contains the set of instructions for controlling access to the appropriate user accounts, and, in one embodiment, also contains instructions for allowing the Copier 140 access to a web page or avatar design created by another user(s) of the system, the Creator 135, In one embodiment, the Graphical User Interface (GUI) Construct module 355 enables the Creator 135 to create a web page or avatar design, or the Copier 140 to modify an existing web page or avatar design. In one embodiment, the GUI Construct module 355 may be provided for the graphical creation of a design. In another embodiment, a simplified GUI Construct module 355 may be provided for copying and pasting design elements from a third-party application. In yet another embodiment, the GUI Construct module 355 could connect directly with a third-party application to receive elements and apply them to the profile design.

In the depicted embodiment, the Creator and Copier gain access to the Web Page or Avatar Design Host Program by establishing a communication link with the system using the Receiver Module 337, the Channel Module, 339, the Transfer module 341, and then authenticating with electronic credentials using the Comms Encryption module 345, the User Account module 353, and the User Accounts Database 105. In one embodiment, the Creator creates a new web page or avatar design using the Receiver module 337, the Channel module 339, the Transfer module 341, the Graphical User Interface (GUI) Construct module 355, the Data Encryption module 349, the Web Page or Avatar Design Database 115, and the Personal Attribute Elements and Information Elements Database 107. The Web Page or Avatar Design Host Program 335 displays the stored profiles or avatars, and their associated personal attribute elements and information elements, of the Creator 135 by establishing a communication channel with the Copier 140 using the Receiver Module 337, the Channel Module 339, the Transfer module 341, The Data Encryption module 349, the Web Page or Avatar Design Database 115, and the Personal Attribute Elements and Information Elements Database 107. The Web Page or Avatar Design Host Program 335 copies the Creator's 135 web page or avatar design for the Copier 140 using the Handler module 351, the Transfer module 341, the User Account module 353, and the Web Page or Avatar Design Database 115. If a purchase was required to initiate the cloning (copying) of the web page or avatar design, then the Receive Module 337, the Channel module 339, the Transfer module 341, the Communication module 343, the Comms Encryption module 345, the Online Purchase module 347, the User Account module 353, and the User Accounts Database 105 are used to carry out the purchase transaction prior to the cloning. Once the cloning is complete, the Communications module 343 is used to notify the Creator 135 and the Copier 140.

In one embodiment the separation between design and personal elements facilitates the cloning of design elements provided by a Creator 135 and associating these with the personal attributes of a Copier 140. In a further embodiment this separation of elements facilitates the capture, storage, and sharing of successive modifications to the original design, and associating these with the personal attributes of second degree, third degree, and further Copiers 140.

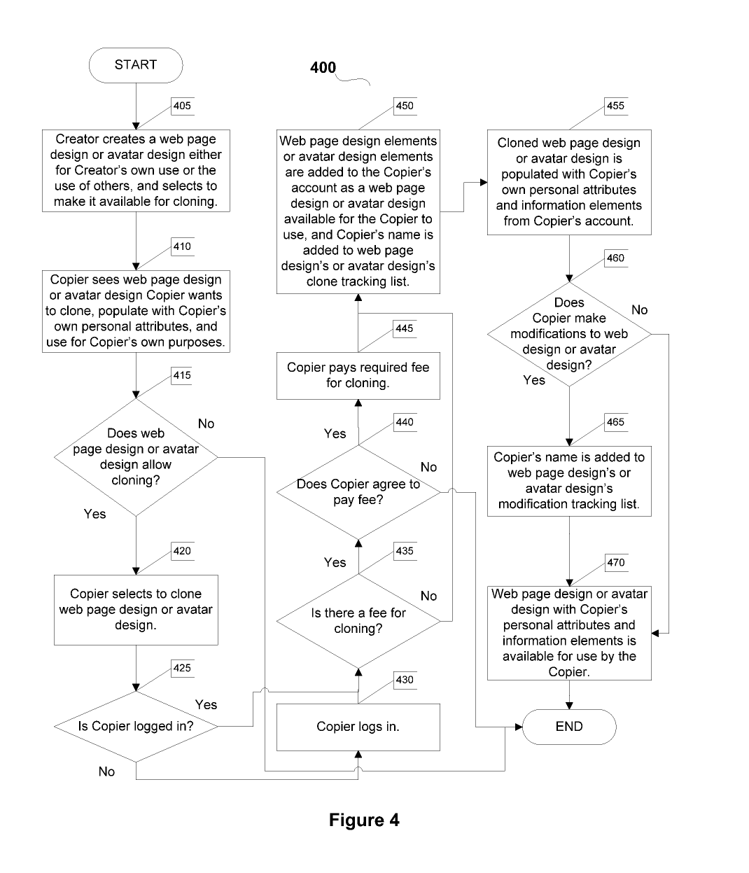

FIG. 4 is schematic flow chart diagram illustrating one embodiment of a method 400 for cloning web page or avatar designs. In step 405 as depicted, the Creator 135 first creates a web page design or avatar design. The web page design or avatar design may initially be for the Creator's 135 own use, the use of someone else, or specifically for cloning by others. In step 410 a Copier 140 sees the sees page or avator design and desires to copy and use it.

In step 415 the Creator 135 specifies that the web page or avatar design is available for cloning. If not, the method goes to End. If so in step 420 the Copier selects to clone the web page design or avatar design. In step 425 the system queries whether the Copier 140 is logged in. If not, in step 430 the Copier 140 logs in. Step 435 determines if there is a fee for cloning and if so in step 440, the Copier 140 pays the fee. If there is no fee for cloning the Copier 140 goes directly to step 450.

In step 450 the Web page design elements or avatar design elements are added to the Copier 140's account and the name of the Copier 140 is added to the system tracking list. Then, in step 455 the cloned web page design or avatar design is populated with the Copier 140's own attributes from the Copier 140's account.

Step 460 queries whether the Copier 140 makes modifications to the web design or avatar design. If not, the web page design or avatar design with Copier 140's personal attributes is available for use by the Copier 140 in step 470. If the Copier 140 makes modifications then in step 465 the Copier's name is added to the web page design or avatar design modification tracking list. The modification tracking list is an active list of Copiers who have made modifications to the web page design or avatar design. The modification tracking list may be accessible by people who are viewing the web page design or avatar design, and may serve as a genealogy of the modifications the web page design or avatar design has undergone. In a further embodiment, the modifications of Copier 140 may be made available for use or purchase by further copiers. In step 470, the web page design or avatar design with Copier 140's personal attributes if available fur use by the Copier 140.

In further embodiments the Creator 135 may select a price to be charged the Copier 140 for cloning the design. When the Creator 135 specifies that the web page design or avatar design be available for cloning, identifying information for the Creator 135 may be added as an authorship attribute to the design. This authorship attribute, which attributes the web page design or avatar design to the Creator 135, remains unchanged no matter how many times, or different persons, clone the design, even if subsequent users make modifications to the design. The web page design may be, for example, but is not limited to, a design for a personal or business profile page for the Creator 135, someone else, or specifically available for cloning. Likewise, if it is an avatar design, the avatar design may be, for example, but is not limited to, for personal or business use by the Creator 135, someone else, or specifically for cloning.

The Copier 140 may see the web page design as the Copier views a web page, such as, but not limited to, the Creator's 135 personal or business profile page, or the personal or business profile page of someone else, or someone who has already cloned the design, or in an online store or listing of web page designs. Likewise, the Copier 140 may see the avatar design, for example, but not limited to, as the Copier 140 interacts with avatars in a virtual realm, or in an online store or listing of avatar designs. The Copier 140 likes the design attributes of the web page design or avatar design, and would like to use the design for the Copier's own purposes. If the Creator 135 of the web page design or avatar design chooses to allow the design to be cloned, then the Copier 140 is able to select, such as, but not limited to, using a mouse like I/O device to click on a button or menu selection, to clone the web page design or avatar design.

In one embodiment if the Copier 140 chooses to make the required payment, then the Copier does so using an online payment method such as, but not limited to, a credit card. Once the online payment is made, the process proceeds to the cloning step. If the web page design or avatar design does not require a payment for cloning then the process proceeds immediately to the cloning step.

When the web page design or avatar design or any elements thereof are cloned, all of the cloned design elements only from the web page design or avatar design are replicated and added to the Copier's account of web page designs or avatar designs 115 available for use. The non-design related information contained in both displaying and non-displaying fields of the original web page design or avatar design are not replicated with the design. The Copier 140's non-design related information from the Copier 140's account 105 corresponding to the displaying and non-displaying fields of the web page design or avatar design are populated into those fields, and the Copier's identifying information is added to the web page design's or avatar design's clone tracking list attribute by the design hosting server 110.

The clone tracking list attribute may be accessible by people who are viewing the web page design or avatar design, and may serve to show how the web page design or avatar design made it from the original Creator 135 to the current Copier 140. The non-design related information populated into the corresponding fields of the web page design or avatar design may be personal information or attributes about the Copier 140, or may be other information the web page design or avatar design displays or makes available. The population of the non-design related information may be a part of the replication process, may be a separate automatic process subsequent to the web page design or avatar design replication, or may be a manual process carried out by the Copier 140 at the time of replication or at a later date.

At this point the web page design or avatar design is now ready for use by the Copier 140. The Copier 140 now uses the web page design or avatar design for the Copier's 140 own purposes, and as the Copier 140 does so, a new Copier may see the web page design or avatar design and want to clone it, and so the process begins again.

The present invention may be embodied in other specific forms without departing from its spirit or essential characteristics. The described embodiments are to be considered in all respects only as illustrative and not restrictive.

What is claimed is:

1. A method for replicating one of a web page design or avatar design, created by one or more person(s) (the creator), and then replicated by one or more person(s) (the copier) desiring to use the web page design comprising:
making viewers of one of a web page or avatar aware the design elements associated with one of the web page or avatar can be cloned (copied) for use by other user(s) of the system; and
when a copier selects to clone (copy) one of the web page or avatar, replacing the creator's personal attribute elements and information elements associated with one of the web page or avatar with the copier's personal attribute elements and information elements.

2. The method of claim 1, further comprising:
the creator choosing to make the web page design available for other user(s) to copy; and
the creator specifying a fee, including no fee, to allow other user(s) to copy the web page design for free; and
providing a mechanism for the user(s) to pay the specified fee.

3. The method of claim 1, further comprising:
adding identification attributes for the creator to the web page design attributes as the original creator of the web page design;
adding identification attributes for subsequent modifier(s) to the web page design attributes as modifier(s) of the web page design.

4. The method of claim 1, further comprising:
storing a user's modifications to the web page design; and
providing a mechanism for the user to make the user's modifications available to subsequent users.

5. A system for replicating one of a web page design or avatar design created by one or more persons(s) comprising:
a personal attribute elements and information elements database; and
one of a web page design or avatar design elements database.

6. The system of claim 5, further comprising:
a design hosting server;
a web page design cloning interface application;
an electronic communication utility;
a network server;
a repository; and
a communication network.

7. An apparatus for replicating one of web page designs or avatar designs, created by one or more person(s), and then replicated by one or more person(s) comprising:
a web page design elements or avatar design elements database configured to store and access the design elements of one of a web page or avatar; and
a personal attribute elements and information elements database configured to store and access the personal attributes and information elements associated with one of a web page or avatar.

8. The apparatus of claim 7, further comprising:
a handler module configured to combine web page design elements from the web page elements design database with personal attributes and information elements from the personal attribute elements and information elements database.

9. The apparatus of claim 8, further comprising:
a user accounts database configured to store and track user accounts; and
a graphical user interface construct module configured to interact with users.

10. The apparatus of claim 9, further comprising:
a receiver module;
a channel module;
a transfer module;
a communications module;
a communications encryption module;
a data encryption module; and
an online purchase module.

11. The method of claim 1, further comprising:
the creator choosing to make the avatar design available for other user(s) to copy; and
the creator specifying a fee, including no fee, to allow other user(s) to copy the avatar design for free; and.
providing a mechanism for the user(s) to pay the specified fee.

12. The method of claim 1, further comprising:
adding identification attributes for the creator to the avatar design attributes as the original creator of the design;
adding identification attributes for subsequent modifier(s) to the avatar design attributes as modifier(s) of the design.

13. The method of claim 1, further comprising:
storing a user's modifications to the avatar design; and
providing a mechanism for the user to make the user's modifications available to subsequent users.

14. The apparatus of claim 7, further comprising:
a handler module configured to combine avatar design elements from the avatar design elements database with personal attributes and information elements from the personal attribute elements and information elements database.

15. The apparatus of claim 14, further comprising:
a user accounts database configured to store and track user accounts; and
a graphical user interface construct module configured to interact with users.

16. The apparatus of claim 15, further comprising:
a receiver module;
a channel module;
a transfer module;
a communications module;
a communications encryption module;
a data encryption module; and
an online purchase module.
